(19) United States
(12) Patent Application Publication
(10) Pub. No.: US 2018/0246269 A1
(43) Pub. Date: Aug. 30, 2018

(54) BACKLIGHT MODULE

(71) Applicants: HKC Corporation Limited, Shenzhen City, Guangdong (CN); Chongqing HKC Optoelectronics Technology Co., Ltd., Chongqing (CN)

(72) Inventor: Yu-Jen CHEN, Chongqing (CN)

(21) Appl. No.: 15/561,731

(22) PCT Filed: Aug. 15, 2017
(86) PCT No.: PCT/CN2017/097493

§ 371 Date: Sep. 26, 2017

(30) Foreign Application Priority Data
Dec. 27, 2016 (CN) 201611229390.5

(51) Int. Cl. F21V 8/00

(52) U.S. Cl. CPC G02B 6/0053; G02B 1/04

(57) ABSTRACT

This application relates to a backlight module, including: a backlight unit; and a prism sheet, disposed on the backlight unit, where the prism sheet includes a first prism structure and a second prism structure, the first prism structure is located in a display area, the second prism structure is located in a peripheral area, vertex angles of the first prism structure and the second prism structure are different, the second prism structure has a right-angled cross section shape, and elevation angles of the second prism structure are arranged towards the display area.

### BACKGROUND

### Technical Field

This application relates to a backlight module, and in particular, to a backlight module applicable to a frameless liquid crystal display (LCD).

### Related Art

In recent years, with the development of science and technologies, various different display devices, for example, LCDs or electro luminescence (EL) display devices have been widely applied to flat panel displays. Using LCDs as an example, most LCDs are backlight-type LCDs including an LCD panel and a backlight module. The LCD panel includes two transparent substrates and a liquid crystal sealed between the substrates.

Because an LCD cannot emit light itself, a backlight module is needed. The backlight module may include a light source such as a light-emitting diode (LED) or a fluorescent lamp, a light guide plate, a prism sheet, a diffuser, a protective sheet, and the like. The prism sheet has a regular pattern of a triangular cross section and focuses light to improve brightness. Generally, a backlight module includes one prism sheet or a plurality of prism sheets stacked on each other. Each prism sheet has a specified pattern located on an upper part of the prism sheet and an irregular pattern located on a lower part of the prism sheet.

An LCD starts to use a frameless design to highlight integrity of a displayed picture. After a frame is removed, a problem of side light leakage at edges needs to be overcome. Otherwise, a phenomenon of peripheral light leakage occurs. A current solution is coating a circle of black adhesive (Side Seal) on an edge end surface of an open cell of a frameless product, to absorb light and prevent light from transmitting. However, this manner requires adding materials and processes and is very inconvenient.

### SUMMARY

To resolve the foregoing technical problem, an objective of this application is to provide a method for designing a backlight module structure, so as to resolve a problem of side light leakage at edges of a frameless LCD.

The objective of this application is achieved and the technical problem of this application is resolved by using the following technical solutions. A backlight module provided according to this application comprises:

a backlight unit; and

a prism sheet, disposed on the backlight unit, where the prism sheet comprises a first prism structure and a second prism structure, the first prism structure is located in a display area, the second prism structure is located in a peripheral area, vertex angles of the first prism structure and the second prism structure are different, the second prism structure has a right-angled cross section shape, and elevation angles of the second prism structure are arranged towards the display area.

In some embodiments, a vertex angle of the second prism structure is smaller than a vertex angle of the first prism structure.

In some embodiments, a vertex angle of the second prism structure is a half of a vertex angle of the first prism structure.

In some embodiments, a vertex angle of the second prism structure is in a range of 30 degrees to 60 degrees.

In some embodiments, a vertex angle of the first prism structure is in a range of 40 degrees to 150 degrees.

In some embodiments, a cross section of the first prism structure in the display area is an isosceles triangle.

In some embodiments, a cross section of the second prism structure in the peripheral area is a right-angled triangle.

In some embodiments, different prism angle areas are configured around the prism sheet.

In some embodiments, the backlight module further comprises at least one optical film, disposed between the backlight unit and the prism sheet.

In some embodiments, the prism sheet is integrated on a light guide plate of the backlight unit, and the first prism structure and the second prism structure are integrated on a light emission surface of the light guide plate.

In some embodiments, prisms of the prism sheet are a plurality of successively arranged triangular ridges and are disposed on light emission surfaces of the prisms.

In some embodiments, a plurality of prisms is arranged on a flat plate, and there are gaps between the prisms.

In some embodiments, the prisms are made of thermoplastic resin.

In some embodiments, the prisms are made of composites of thermoplastic resin.

In some embodiments, the prism sheet has a compound angle of a plurality of prism angles.

An objective of this application is to provide a backlight module, comprising:

a backlight unit, including a light source and a light guide plate;

a prism sheet, disposed on the backlight unit, where the prism sheet comprises a first prism structure and a second prism structure, the first prism structure is located in a display area, the second prism structure is located in a peripheral area, vertex angles of the first prism structure and the second prism structure are different, the second prism structure has a right-angled cross section shape, and elevation angles of the second prism structure are arranged towards the display area; and

at least one optical film, disposed between the backlight unit and the prism sheet, where

a vertex angle of the second prism structure is smaller than a vertex angle of the first prism structure; a vertex angle of the second prism structure is in a range of 30 degrees to 60 degrees; a vertex angle of the first prism structure is in a range of 60 degrees to 150 degrees; and a cross section of the first prism structure in the display area is an isosceles triangle; and

the prism sheet is integrated on the light guide plate; and the first prism structure and the second prism structure are integrated on a light emission surface of the light guide plate.

In some embodiments of this application, several successively arranged triangular ridges are disposed on a light emission surface of the prism sheet.

Beneficial effects of this application are resolving a problem of side light leakage at edges of a frameless LCD. In addition, a circle of black adhesive does not need to be coated on the frameless LCD to absorb leaking light, so that a process is more convenient, and a prism sheet having a compound angle is used to form total reflection around, to reduce light refracted from a glass end surface and avoid light leakage at edges of a frameless product.

### BRIEF DESCRIPTION OF THE DRAWINGS

FIG. 1 is a schematic structural diagram of a backlight module of an exemplary conventional LCD;

FIG. 1a is a schematic diagram of a design of an outer frame of an exemplary display panel;

FIG. 1b is a schematic diagram of a frameless design of a display panel according to an embodiment of this application;

FIG. 2a is a schematic diagram of an exemplary design with a frame;

FIG. 2b is a schematic diagram of a frameless side seal design according to an embodiment of this application;

FIG. 3a is perspective view of a prism sheet according to an embodiment of this application;

FIG. 3b is a schematic diagram of a frameless LCD with a prism sheet having a compound angle according to an embodiment of this application; and

FIG. 4 is a schematic diagram of a part of a cross section of a light guide plate according to an embodiment of this application.

### DETAILED DESCRIPTION

The following embodiments are described with reference to the accompanying drawings, and are used to exemplify specific embodiments for implementation of this application. Terms about directions mentioned in this application, such as “on”, “below”, “front”, “back”, “left”, “right”, “in”, “out”, and “side surface” merely refer to directions in the accompanying drawings. Therefore, the used terms about directions are used to describe and understand this application, and are not intended to limit this application.

The accompanying drawings and the description are considered to be essentially exemplary, rather than limitative. In the figures, modules with similar structures are represented by using the same reference number. In addition, for understanding and ease of description, a size and a thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a base is described to be “on” “another component”, the component may be directly on the another component, or there may be an intermediate component.

In addition, in this specification, unless otherwise explicitly described to have an opposite meaning, the word “include” is understood as including the component, but not excluding any other component. In addition, in this specification, “on” means that a component is located above or below a target component and does not mean that the component needs to be located on the top based on a gravity direction.

To further describe the technical means used in this application to achieve the application objective and effects thereof, specific implementations, structures, features, and effects of an LCD device provided according to this application are described in detail below with reference to the drawings and preferred embodiments.

An LCD applies an electric field to a liquid crystal between two glass substrates, to display numbers or images. The liquid crystal is formed by a substance intermediate between liquid and solid. Because the LCD cannot emit light itself, a backlight module is needed to provide light. A picture is formed by controlling transmission of light of an LCD panel. The liquid crystal is uniformly disposed in the LCD panel.

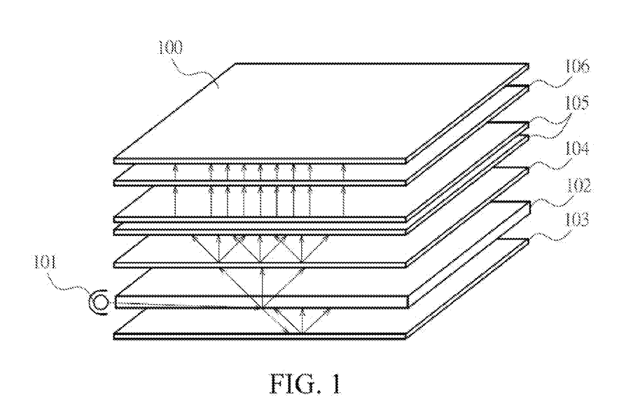

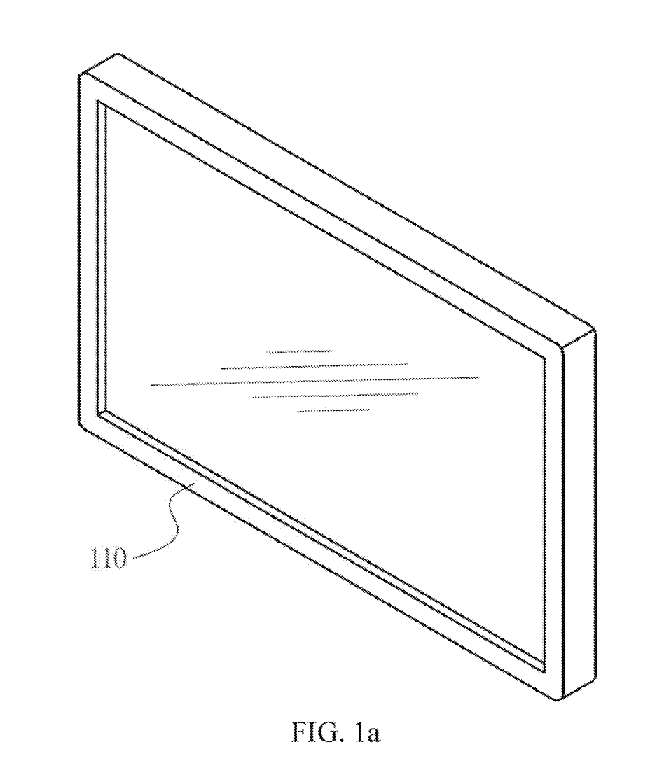

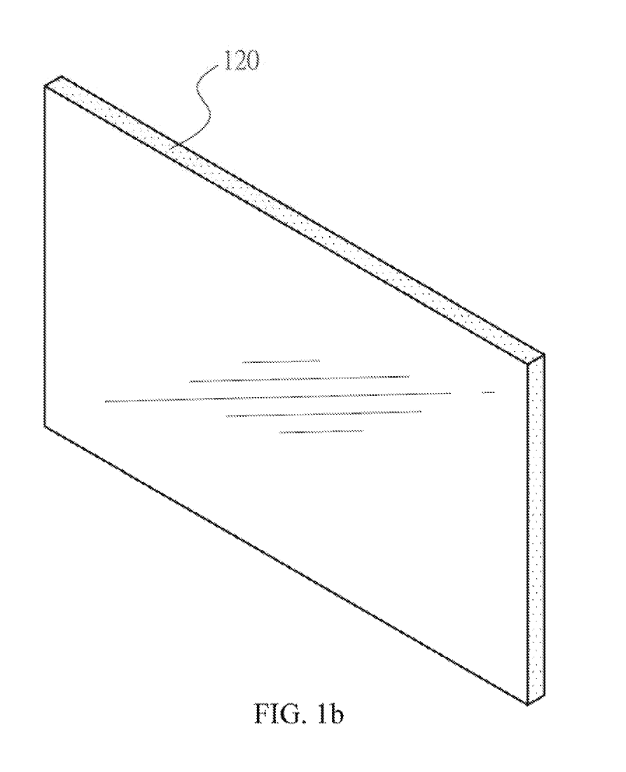

The backlight module (as shown in FIG. 1) of the LCD includes a light source 101, a light guide plate 102, a reflector sheet 103, a diffuser 104, a prism sheet 105, and a protective sheet 106. First, the light source 101 is used to emit light to the LCD. Currently, a plurality of different light sources can be applied to the LCD. The light guide plate 102 is disposed below an LCD panel 100 and is adjacent to one side of the light source 101. The light guide plate 102 is used to convert dotted light generated by the light source 101 into planar light and project the planar light to the LCD panel 100.

The reflector sheet 103 is disposed below the light guide plate 102. The reflector sheet 103 is used to reflect light emitted by the light source 101 to the LCD panel 100 in front of the reflector sheet 103. The diffuser 104 is disposed on the light guide plate 102 and is used to uniformize light penetrating through the light guide plate 102. When light penetrates through the diffuser 104, the light is diffused on a horizontal direction and a vertical direction. In this case, brightness of light rapidly decreases. For this, the prism sheet 105 is used to refract and focus light, so as to improve brightness. Generally, two prism sheets 105 are arranged in a manner of being perpendicular to each other.

The protective sheet 106 is disposed on the prism sheet 105. When two prism sheets 105 arranged in a manner of being perpendicular to each other are used, the protective sheet 106 can avoid scratches on the prism sheets 105, and prevent a phenomenon of a moire effect. A backlight module of a conventional LCD includes the foregoing components. A new technical featureof the prism sheet 105, is added to this application.

When the prism sheet 105 is normally assembled, a plurality of unit prisms is arranged on a film made of a transparent material in a regular direction. The prism sheet 105 is configured to refract light penetrating through the light guide plate 102 and diffused by the diffuser 104. Generally, if widths of transmitted light and refracted light are relatively small, light in transmission and refraction areas is relatively bright. On the contrary, if widths of transmitted light and refracted light are relatively large, light in transmission and refraction areas is relatively dim.

An LCD device of this application may include a backlight module and an LCD panel. The LCD panel may include: a thin-film transistor substrate, a color filter substrate, and a liquid crystal layer formed between the two substrates. A prism sheet may be applied to LCD to improve front brightness of a display screen.

In an embodiment, the LCD panel of this application may be a curved display panel, and the LCD device of this application may also be a curved display apparatus.

FIG. 1a is a schematic diagram of a design of an outer frame of an exemplary display panel; FIG. 1b is a schematic diagram of a frameless design of a display panel according to an embodiment of this application. Referring to FIG. 1a and FIG. 1b, a thin-film transistor LCD starts to use a frameless design to highlight integrity of a displayed picture. After a frame 110 is removed, a problem of side light leakage at edges needs to be overcome. Otherwise, a phenomenon of peripheral light leakage occurs. A current solution is coating a layer of black adhesive 120 on an edge end surface of an open cell of a frameless product, to absorb light and prevent light from transmitting. However, this manner requires adding materials and processes and is very inconvenient.

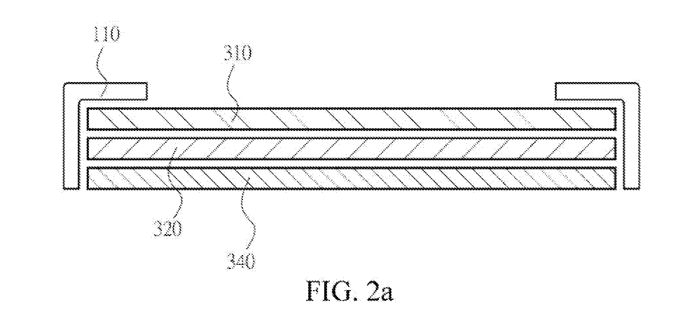

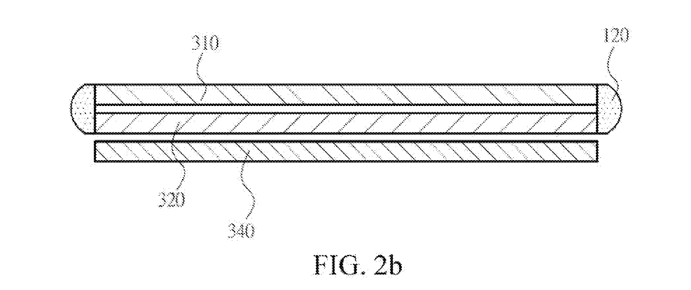

FIG. 2a is a schematic diagram of an exemplary design with a frame; FIG. 2b is a schematic diagram of a frameless side seal design according to an embodiment of this application. Referring to FIG. 2a and FIG. 2b, a light leakage problem at a side 110 needs to be resolved when there is no frame. A layer of black adhesive 120 is coated on an edge end surface of an open cell, to absorb light and prevent light from transmitting. However, this manner requires adding materials and processes and is very inconvenient.

This application uses light focusing features of a prism sheet to focus light beams and uses a relationship between a glass refractive index and an air refractive index to make light maintained at total reflection conditions and prevent light from transmitting outwards. Because the glass refractive index is larger than the air refractive index, an incident angle at a glass end is larger than a refraction angle at an air end. When incident light is at a particular angle, total reflection conditions can be formed. However, because the incident angle is excessively small and does not reach a total reflection critical angle, light leakage always exists. Therefore, this application uses a principle of the prism sheet. A prism angle close to edges of an external area changes, making an optical path of a light source more vertical. Even if incline occurs, an angle of the incline is very small. A smaller angle is more advantageous to reach a total reflection critical. Features of the design are a compound prism angle and prism angles gathered on the periphery are smaller than prism angles of a display area.

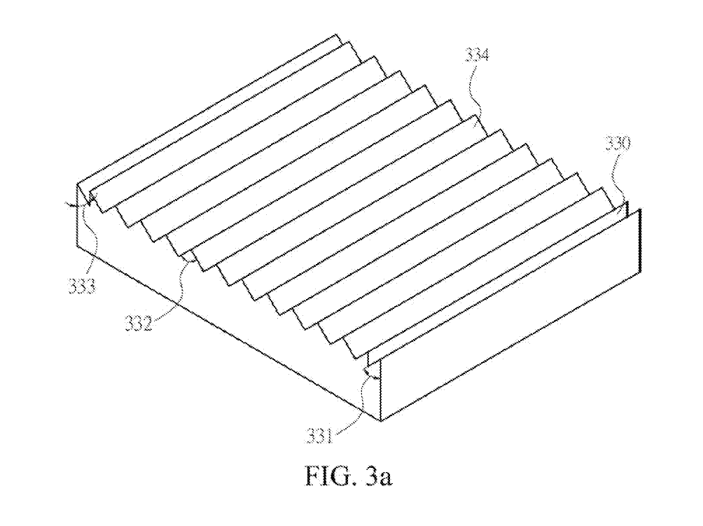

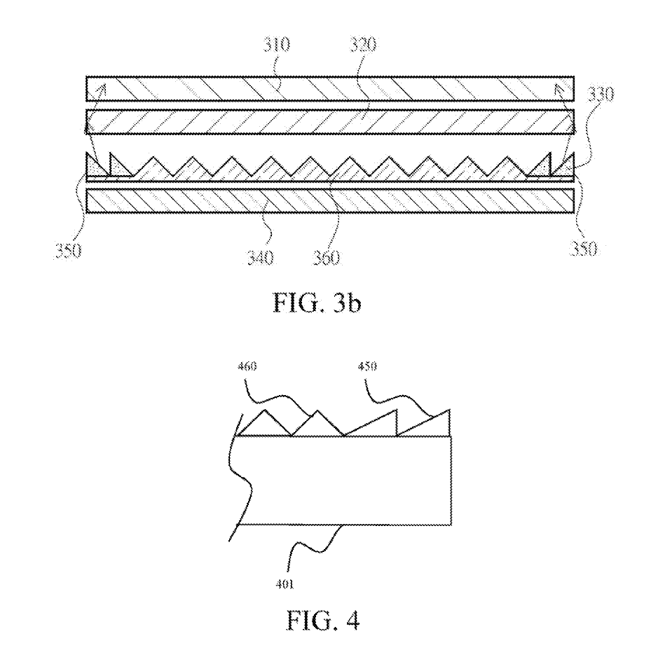

FIG. 3a is perspective view of a prism sheet according to an embodiment of this application; FIG. 3b is a schematic diagram of a frameless LCD with a prism sheet having a compound angle according to an embodiment of this application. Referring to FIG. 3a and FIG. 3b, in an embodiment of this application, a frameless LCD may include: an active switch array substrate 320, a color filter substrate 310, a prism sheet 330, and a backlight unit 340. A plurality of prisms distributed on the prism sheet 330 separately includes at least one prism angle (331, 332, 333). In addition, angles of prisms 334 on the prism sheet 330 in a peripheral area 350 are smaller than those in a display area 360. An LCD panel may be a thin-film transistor LCD panel or a curved panel, or may be another backlight-type LCD panel.

Referring to FIG. 3a and FIG. 3b, in this embodiment of this application, the backlight module may include: the prism sheet 330 and the backlight unit 340. The prism sheet 330 is disposed on the backlight unit 340, where the prism sheet includes a first prism structure 360 and a second prism structure 350, the first prism structure 360 is located in the display area, the second prism structure 350 is located in the peripheral area, vertex angles of the first prism structure 360 and the second prism structure 350 are different, the second prism structure has a right-angled cross section shape, and elevation angles of the second prism structure are arranged towards the display area.

Specifically, in some embodiments, the first prism structure 360 in the display area may be aligned to a display area of the LCD panel, and a cross section of the first prism structure 360 in the display area may be an isosceles triangle. The second prism structure 350 on the peripheral area may be aligned to a non-display area of the LCD panel, and a cross section of the second prism structure 350 may be a right-angled triangle. Elevation angles of the right-angled triangle of the second prism structure 350 are arranged towards the first prism structure 360 in the display area.

In an embodiment of this application, a principle of light focusing of the prism sheet 300 is used to configure different angle areas (331, 332, 333) of the prisms 334 on the periphery of the prism sheet 330, so as to effectively form an inward shrinking light shape and help form total reflection conditions of glass and an air interface, to prevent light from transmitting out of glass to avoid light leakage. By means of this design, for the frameless LCD, a circle of black adhesive does not need to be coated on the periphery of the LCD panel to absorb leaking light, so that a process is more convenient.

Referring to FIG. 3a and FIG. 3b, in an embodiment of this application, a vertex angle (331, 333) of the second prism structure in the peripheral area of the prism sheet 330 is in a range of 30 degrees to 65 degrees. The vertex angle 332 of the second prism structure 360 in the display area of the prism sheet is in a range of 40 degrees to 150 degrees, or, for example, in a range of 60 degrees to 150 degrees.

In some embodiments, a vertex angle of the second prism structure may be smaller than a vertex angle of the first prism structure.

In some embodiments, a vertex angle of the second prism structure may be, for example, a half of a vertex angle of the first prism structure.

In some embodiments, a vertex angle of the second prism structure is, for example, in a range of 30 degrees to 60 degrees.

In some embodiments, a vertex angle of the first prism structure is, for example, in a range of 40 degrees to 150 degrees.

In some embodiments, a cross section of the first prism structure in the display area may be an isosceles triangle.

In some embodiments, the backlight module further includes at least one optical film, disposed between the backlight unit 340 and the prism sheet 330. The optical film may be, for example, a diffuser, a prism sheet, a turning prism sheet, a brightness enhancement film (BEF), a dual brightness enhancement film (DBEF), a diffused reflective polarizer film (DRPF), or any combination thereof, and is disposed on the light guide plate, to improve an optical effect of light emission of the backlight unit 340.

Referring to FIG. 3a and FIG. 3b, in an embodiment of this application, the prisms 334 of the prism sheet 330 are a plurality of successively arranged triangular ridges or other shaped ridges, and are disposed on light emission surfaces of the prisms 334.

Referring to FIG. 3a and FIG. 3b, in an embodiment of this application, there are no gaps between a plurality of prisms 334.

Referring to FIG. 3a and FIG. 3b, in an embodiment of this application, the plurality of prisms 334 is arranged on a flat plate, and there are fixed gaps between the plurality of prisms 334.

Referring to FIG. 3a and FIG. 3b, in an embodiment of this application, the prism sheet has a compound angle of a plurality of prism angles, and forms total reflection around, to reduce light refracted from a glass end surface.

Referring to FIG. 3a and FIG. 3b, in an embodiment of this application, angles of the prisms 334 on the prism sheet 330 in the second prism structure 350 in the peripheral area are smaller than those in the first prism structure 360 in the display area.

Referring to FIG. 3a, in an embodiment of this application, a group of prism sheets includes one or more prisms 334.

In an embodiment of this application, the backlight unit 340 may include a light guide plate; and a light source, disposed on a side surface or a back surface of the light guide plate. The light source may be, for example, a cold cathode fluorescent lamp (CCFL), a hot cathode fluorescent lamp (HCFL), an LED, an organic light emitting diode (OLED), a flat fluorescent lamp (FFL), an EL component, a light bar, a laser light source, or any combination thereof.

However, the light source is not limited thereto. In some embodiments, the backlight unit 340 may be a direct-type backlight unit and a light guide plate does not need to be disposed.

Referring to FIG. 3b, in an embodiment of this application, the LCD panel further includes an active switch array substrate 320 and a color filter substrate 310.

In an embodiment of this application, the prisms 334 of the prism sheet 330 may be made of, for example, thermoplastic resin or composites including thermoplastic resin. The thermoplastic resin is transparent in a range of visible light. Examples of the thermoplastic resin may include a polyoxymethylene resin, acrylic resin, a polycarbonate resin, a polystyrene resin, a polyester resin, a vinyl resin, a polyphenylether resin, a polyolefin resin, a cycloolefine resin, an acrylonitrile-butadiene-styrene copolymer, a polypropylene resin, a polyaryl sulfone resin, a polyphenylene sulfide resin, a polyethylene naphthalate resin, a polyethylene resin, and a fluororesin.

Referring to FIG. 4, FIG. 4 is a schematic diagram of a part of a cross section of a light guide plate according to an embodiment of this application. In an embodiment of this application, the prism sheet may be directly integrated on a light guide plate 401 of the backlight unit. In this embodiment, a second prism structure 450 in the peripheral area and a first prism structure 460 in the display area may be directly integrated on a light emission surface of the light guide plate 401, so as to reduce disposition costs of the prism sheet.

Beneficial effects of this application are resolving a problem of side light leakage at edges of a frameless LCD. In addition, a circle of black adhesive does not need to be coated on the frameless LCD to absorb leaking light, so that a process is more convenient, and a prism sheet having a compound angle is used to form total reflection around, to reduce light refracted from a glass end surface and avoid light leakage at edges of a frameless product.

Phases such as “in some embodiments” and “in various embodiments” are repeatedly used. The phases usually refer to different embodiments, but they may also refer to a same embodiment. Words such as “comprise”, “have”, and “include” are synonyms, unless other meanings are indicated in the context.

Descriptions above are merely preferred embodiments of this application, and are not intended to limit this application in any form. Although this application has been disclosed above by using preferred embodiments, the embodiments are not intended to limit this application. A person skilled in the art can make some equivalent variations, alterations or modifications to the above disclosed technical content without departing from the scope of the technical solutions of this application to obtain equivalent embodiments. Any simple alteration, equivalent change or modification made to the foregoing embodiments according to the technical essence of this application without departing from the content of the technical solutions of this application shall fall within the scope of the technical solutions of this application.

What is claimed is:

1. A backlight module, comprising:
a backlight unit; and
a prism sheet, disposed on the backlight unit, wherein the prism sheet comprises a first prism structure and a second prism structure, the first prism structure is located in a display area, the second prism structure is located in a peripheral area, vertex angles of the first prism structure and the second prism structure are different, the second prism structure has a right-angled cross section shape, and elevation angles of the second prism structure are arranged towards the display area.

2. The backlight module according to claim 1, wherein a vertex angle of the second prism structure is smaller than a vertex angle of the first prism structure.

3. The backlight module according to claim 2, wherein the vertex angle of the second prism structure is a half of the vertex angle of the first prism structure.

4. The backlight module according to claim 1, wherein a vertex angle of the second prism structure is in a range of 30 degrees to 60 degrees.

5. The backlight module according to claim 1, wherein a vertex angle of the first prism structure is in a range of 40 degrees to 150 degrees.

6. The backlight module according to claim 1, wherein a cross section of the first prism structure in the display area is an isosceles triangle.

7. The backlight module according to claim 1, wherein a cross section of the second prism structure in the peripheral area is a right-angled triangle.

8. The backlight module according to claim 1, wherein different prism angle areas are configured around the prism sheet.

9. The backlight module according to claim 1, further comprising at least one optical film, disposed between the backlight unit and the prism sheet.

10. The backlight module according to claim 1, wherein prisms of the prism sheet are a plurality of successively arranged triangular ridges and are disposed on light emission surfaces of the prisms.

11. The backlight module according to claim 10, wherein a plurality of prisms is arranged on a flat plate, and there are gaps between the prisms.

12. The backlight module according to claim 10, wherein the prisms are made of thermoplastic resin.

13. The backlight module according to claim 10, wherein the prisms are made of composites of thermoplastic resin.

14. The backlight module according to claim 1, wherein the prism sheet has a compound angle of a plurality of prism angles.

15. The backlight module according to claim 1, wherein the prism sheet is integrated on a light guide plate of the backlight unit.

16. The backlight module according to claim 15, wherein the first prism structure and the second prism structure are integrated on a light emission surface of the light guide plate.

17. A backlight module, comprising:
a backlight unit, comprising a light source and a light guide plate;
a prism sheet, disposed on the backlight unit, wherein the prism sheet comprises a first prism structure and a second prism structure, the first prism structure is located in a display area, the second prism structure is located in a peripheral area, vertex angles of the first prism structure and the second prism structure are different, the second prism structure has a right-angled cross section shape, and elevation angles of the second prism structure are arranged towards the display area; and
at least one optical film, disposed between the backlight unit and the prism sheet, wherein
a vertex angle of the second prism structure is smaller than a vertex angle of the first prism structure; a vertex angle of the second prism structure is in a range of 30 degrees to 60 degrees; a vertex angle of the first prism structure is in a range of 60 degrees to 150 degrees; and a cross section of the first prism structure in the display area is an isosceles triangle; and
the prism sheet is integrated on the light guide plate; and the first prism structure and the second prism structure are integrated on a light emission surface of the light guide plate.
